(19) United States
(12) Patent Application Publication
(10) Pub. No.: US 2020/0124065 A1
(43) Pub. Date: Apr. 23, 2020

(54) Roof pipe ornament support

(71) Applicant: William Ralph Bond, Manassas, VA (US)

(72) Inventor: William Ralph Bond, Manassas, VA (US)

(21) Appl. No.: 16/501,453

(22) Filed: Apr. 18, 2019

Related U.S. Application Data
(63) Continuation-in-part of application No. 16/350,235, filed on Oct. 18, 2018, now Pat. No. 10,582,758.

(51) Int. Cl. F16B 2/06; E04D 13/143; E04D 13/17; F16M 13/02

(52) U.S. Cl. CPC F16B 2/065; F16M 13/02; E04D 13/17; E04D 13/143

(57) ABSTRACT

An ornamental support member for supporting a decorative ornament on the roof pipe of a house for improving the outward appearance of the house. The ornamental support member is in the form of an outer elongated truncated cone-shaped component attached to an inner cylindrically shaped component spaced therefrom with air permeable discs secured at opposite ends of said ornamental support member for allowing the passage of undesired gases into the atmosphere.

This application is a continuation-in-part of application Ser. No. 16/350,235 filed on Nov. 19, 2018.

### BACKGROUND OF THE INVENTION

### 1. Field of the Invention

The present invention relates to a support for an ornament on a roof pipe.

### 2. Description of the Related Art

There is little prior art on this field of endeavor. A Chinese patent CN201627312 discloses a precast ornament 1 in the apparent shape of a vase surrounding an exhaust roof pipe 2 which ornament is mainly supported by the roof of a building and is apparently stabilized by a member 3 between the inside of the ornament 1 and the exhaust roof pipe 2 as shown in FIGS. 1-5 of the Chinese patent.

### SUMMARY OF THE INVENTION

It is an object of this invention to improve the appearance of an exhaust roof pipe extending from the roof of a house which appearance is generally an eye sore when viewed from the ground on a side of the house by providing a decorative ornament over the top of the exhaust roof pipe.

It is another object of this invention to provide an ornamental support member which can be easily slid over the top or open end of an exhaust roof pipe and secured thereto by a set screw in the side of the support member.

It is another object of this invention to provide several variations of this support member in order to support several ornaments of varying types. Basically, the support member is in the shape of a castle turret that slides over the open end of a cylindrically shaped exhaust roof pipe.

The support member itself is cylindrically shaped and has a disc inserted therein which rests on a rim or ledge therein. The disc itself has several openings therein for house exhaust gas to pass therethrough. The cylindrical support member has several cut-outs around the upper end thereof for the house exhaust gas to pass therethrough. The cut-outs are preferably rectangularly shaped but may also have other shapes as long as the house exhaust gas can pass therethrough. The disc can be molded within the cylindrical support member during manufacture or may be temporally manually held inside the cylindrical support member during the attachment of the decorative ornament to the cylindrical support member, which assembly will be explained hereinbelow.

The theme of the decorative ornament itself is selected by the owner of the house such theme as military, nature, gospel, etc., and does not affect the function of the exhaust roof pipe.

Other objects and advantages for the use of the support member of this invention will become apparent upon reading the following description of which the attached drawings form a part.

### BRIEF DESCRIPTION OF THE DRAWINGS

FIG. 1 is a perspective view of a first ornamental cylindrical support member of this invention.

FIG. 2 is top plan view of the ornamental support member shown in FIG. 1.

FIG. 3A is a bottom plan view of the ornamental support member shown in FIG. 1 without an inner disc.

FIG. 3B is a bottom plan view of the ornamental support member shown in FIG. 1 with an inner disc.

FIG. 4 is a side elevational view of the ornamental support member shown in FIG. 1.

FIG. 5 is a cross sectional view through lines 5-5 shown in FIG. 1.

FIG. 6 is a top plan view of a disc supported within the inner surface of the ornamental support member shown in FIG. 1.

FIG. 7 is a side elevational view of the disc shown in FIG. 6.

FIG. 8 is a schematic showing of the manual assembly of an ornamental eagle being attached to the ornamental cylindrical support member of this invention.

FIG. 9 is a view of the completed assembly of the parts shown in FIG. 8.

FIG. 10 is a view of a roof pipe and flashing typically found on the roof of a house.

FIG. 11 is a showing of the ornamental support member slid over and fixed to the cylindrical exhaust gas pipe on the roof of a house.

FIG. 12 is a view of an alternative modification of the cylindrical support member shown in FIG. 1 with a crossing bar affixed thereto.

FIG. 13 is a showing of the assembly of FIG. 12 with a pair of decorative ornaments affixed to opposite ends of the crossing bar.

FIG. 14 is a showing using an assembly similar to FIG. 13 supporting an eagle ornament.

FIG. 15 is a showing of a different ornament, i. e., a cross, supported by the ornamental support member of this invention which, in turn, is supported on the cylindrical exhaust gas roof pipe of a house.

FIG. 16 is a perspective view of a second ornamental support member of this invention with an outline of an inner cylindrically shaped component.

FIG. 17 is a top plan view of FIG. 16 showing an upper disc at the top end of the ornamental support member.

FIG. 18 is a bottom plan view of FIG. 16 showing an inner disc of the ornamental support member.

FIG. 19 is a cross-sectional view through lines 19-19 of the ornamental support member shown in FIG. 16.

FIG. 20 is a top plan view of an upper disc of the ornamental support member shown in FIG. 16.

FIG. 21 a is a side elevational view of the upper disc shown in FIG. 20.

FIG. 22 is a top plan view of the inner disc of the ornamental support member shown in FIG. 18.

FIG. 23 is a side elevational view of the inner disc shown in FIG. 22.

FIG. 24 is an exploded perspective view showing the separate parts used in the manual assembly of the ornamental support member supporting an eagle ornament.

FIG. 25 is a separate view of the eagle ornament with a threaded bolt attached thereto.

FIG. 26 is a view of the completed assembly of the separate parts of FIG. 24 slid over the roof pipe of a shingled roof.

FIG. 27 is a partially broken away view of FIG. 26 without the physical sphere attached to the decorative ornament.

FIG. 28 is a partially broken away view of FIG. 26 with a crossing bar and crystal balls attached thereto

### DESCRIPTION OF THE PREFERRED EMBODIMENTS

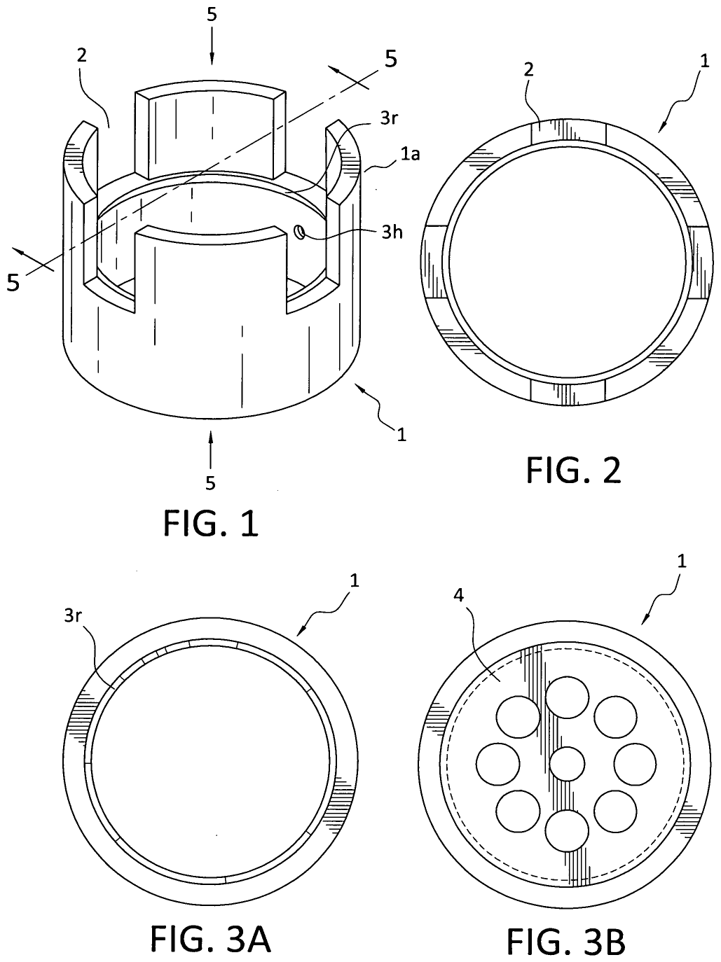

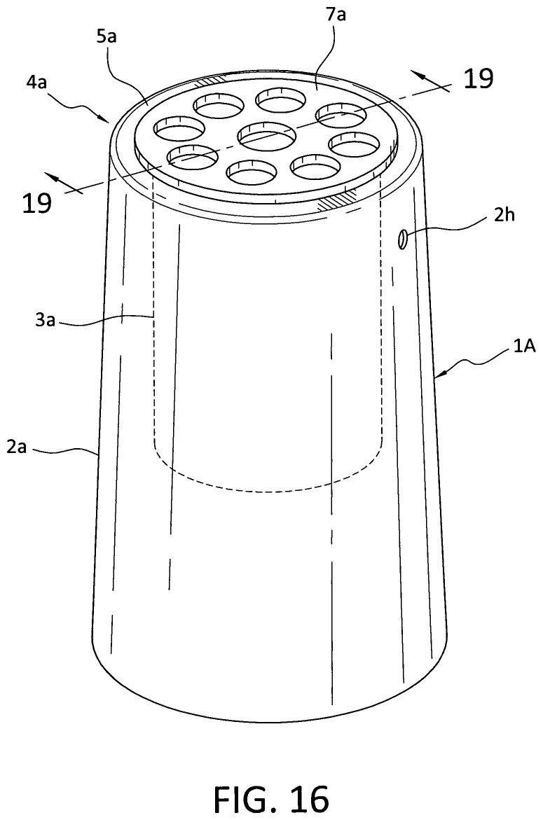

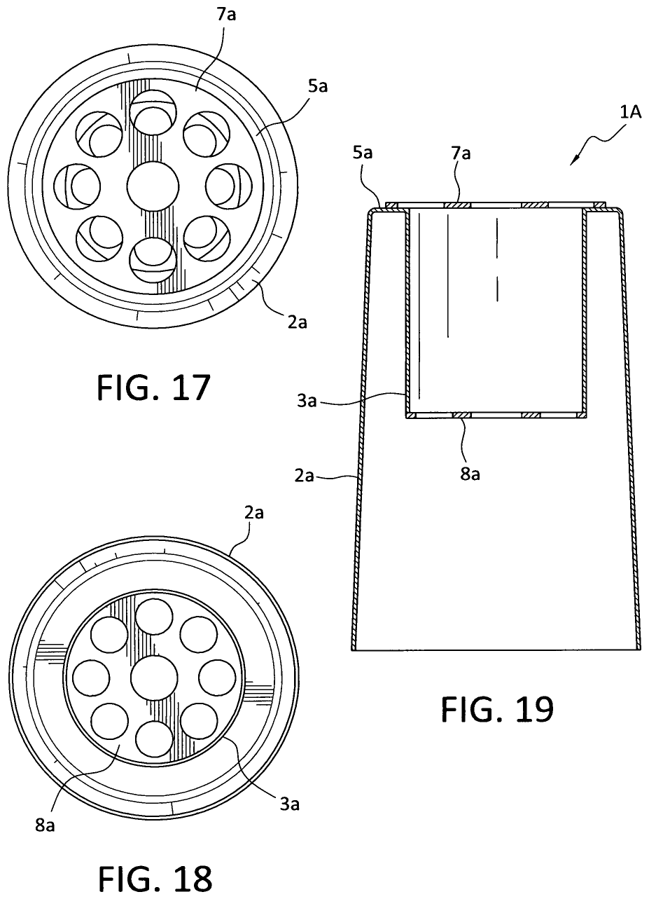

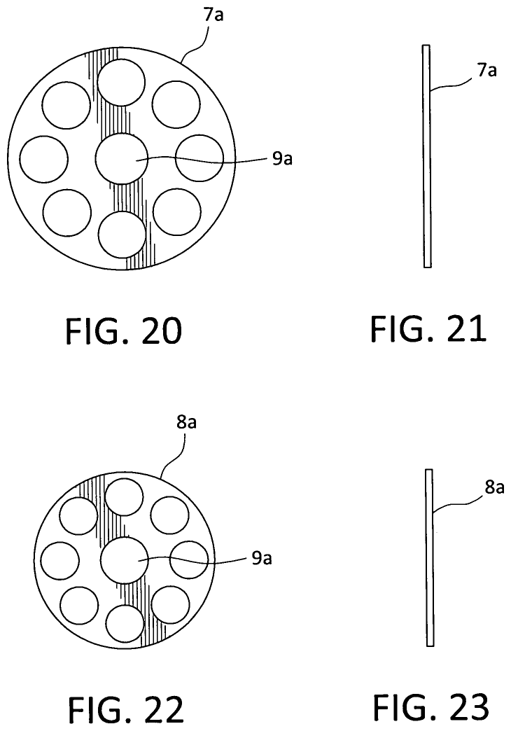

As herein described, there are two embodiments of this invention. The first embodiment described is in reference to FIGS. 1-15 of the drawings. The second embodiment described is in reference to FIGS. 16-26 of the drawings.

The first embodiment of this invention is shown in FIG. 1 wherein an ornamental support member 1 has the general shape of a castle turret 1a with several cut-outs 2 around its periphery. To simplify the description of the ornamental support member 1 of this invention specific dimensions are given herein to fit over a roof gas exhaust pipe with a diameter of 3.5 inches although it would be obvious to one skilled in the art to readily determine the dimensions for an ornamental support member to fit over one of the other three standard size roof pipes. The shape of the cut-outs 2 in the castle turret 1a are preferably rectangular but may take other shapes as long as they allow house sewer gasses to escape to the outer atmosphere. The number of cut-outs 2 are preferably four but may be another number depending on the necessity. The radial length of each cut-out 2 is approximately 1.75 inches with a height of approximately 1 and ⅜ inches. The spacing between adjacent cut-outs 2 is approximately 1.00 inch. There is a threaded hole 3h in the wall of the ornamental support member 1 to accommodate a set screw 3s to secure the ornamental support 1 to an exhaust roof pipe RP which procedure will be explained later herein. The ornamental support member 1 of this invention may be dimensioned to accommodate different standard size roof pipes such as 1.5 inch, 2 inches, 3.5 inches and 4 inches. The outer diameter of the circumferential ornamental support member 1 of this invention is approximately 4 inches and its inner diameter is approximately 3.5 inches. The height of the ornamental support member 1 is approximately 3 inches. There is a circumferential ridge or ledge 3r on the inner surface of the ornamental support member 1 just below the four cut-outs 2 with a depth of approximately 0.20 inch and is located approximately 1 and ½ inches from the bottom end of ornamental support member 1.

In FIG. 3A, there is shown a top plan view of the ornamental support member 1 and the location of a ridge 3r on an inner wall of the ornamental support member 1.

In FIG. 38, there is shown a bottom plan view of the ornamental support member 1 with an inner disc 4 positioned within the ornamental support member 1.

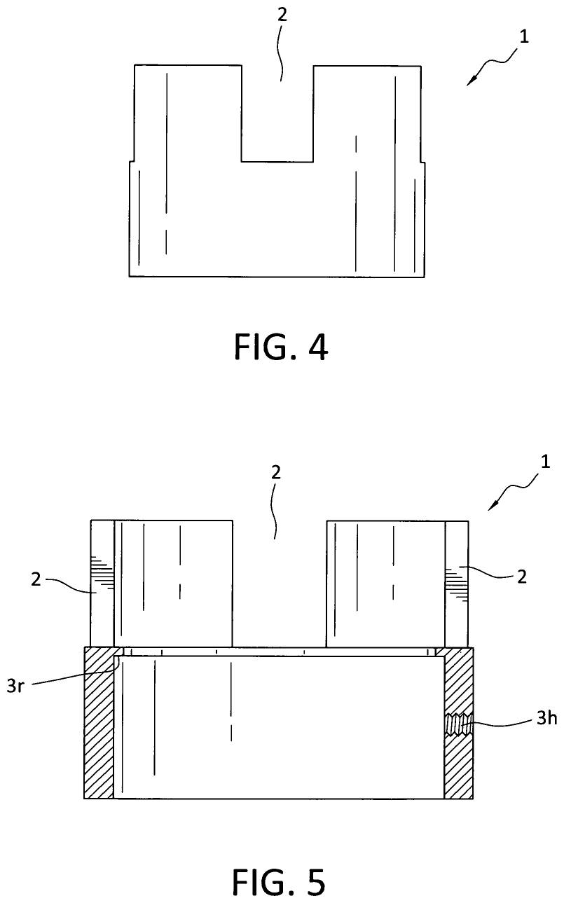

FIG. 4 is a side elevational view of the ornamental support member 1 having a height of approximately 3 inches as previously explained.

FIG. 5 is a cross sectional view through lines 5-5 of the ornamental support member 1 shown in FIG. 1.

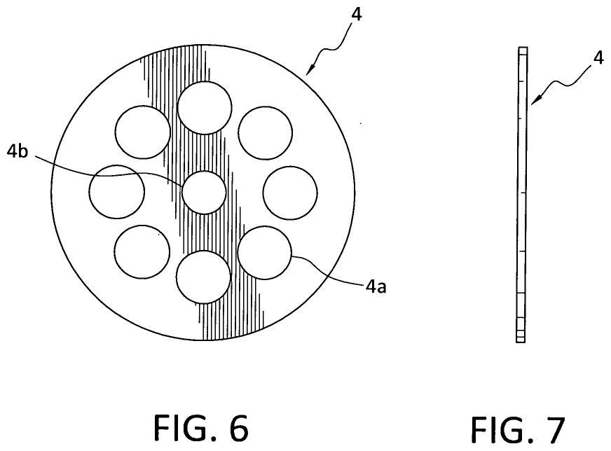

As shown in FIG. 6 the inner disc 4 has several openings 4a therein surrounding a central opening 4b. The inner disc 4 is approximately 3.50 inches in diameter. Each of the several openings 4a is approximately 0.625 inch in diameter and the central opening 4 b is approximately 0.50 inch in diameter to accommodate the passage of an elongated threaded bolt TB therethrough, which will be explained later herein. The thickness of the inner disc 4 as shown in FIG. 7 is approximately 0.09 to 0.10 inch. The inner disc 4 may be manually positioned within the ornamental support member 1 to rest on the free surface of a ridge or ledge 3r (which will be explained later herein during an assembly process) or it may be molded within the ornamental support member 1 itself during a manufacturing process. The ornamental support member 1 (including its inner disc 4) of this invention is preferably made from aluminum but other suitable materials such as PVC and ABS plastics, or other suitable, durable and sturdy material may also be used.

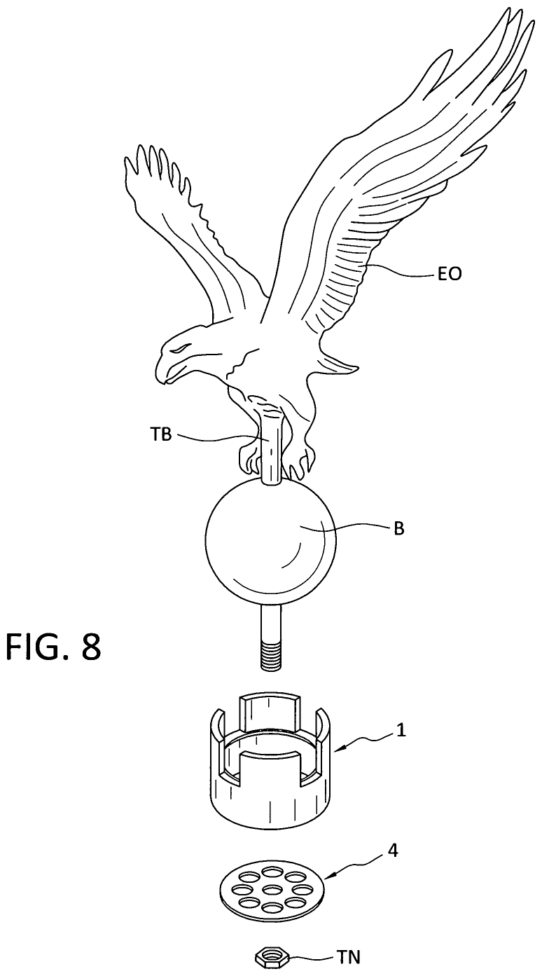

FIG. 8 shows the manual assembly of a decorative ornament EO, i. e., an eagle, being assembled to the ornamental support member 1 of this invention. In the case where the inner disc 4 is a free element: the inner disc 4 is manually inserted into the open bottom end of the ornamental support member 1 up to the inner ridge 3r while inserting an elongated threaded bolt TB (attached to the ornament EO, e. g., an eagle) through a through-hole in a ball shaped member B, and thence through the central opening 4b in the inner disc 4. Finally, a threaded nut TN is screwed onto the free end of the threaded bolt TB of the ornament EO and tightened up to the bottom free end of the inner disc 4 until all components of the assembly are securely fixed together. In the case where the inner disc 4 is molded within the ornamental support member 1 during the manufacturing process the manual step of inserting the free inner disc 4 into the ornamental support member is unnecessary. The ball shaped member B can be a solid body with a center through hole or a hollow body with opposing openings therein. The ball shaped body is preferably made from metal, e. g., aluminum, but other suitable metals or sturdy plastic materials may also be used for the ball B.

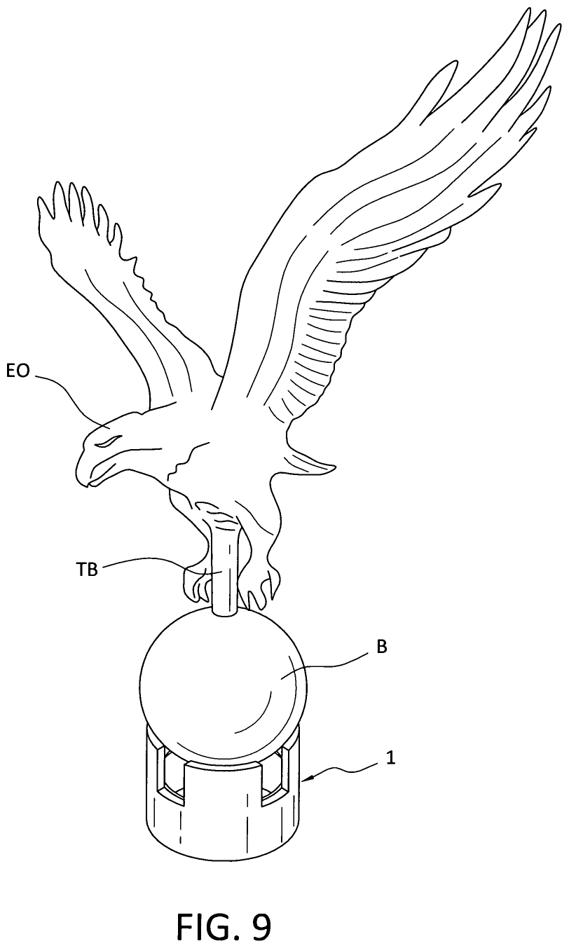

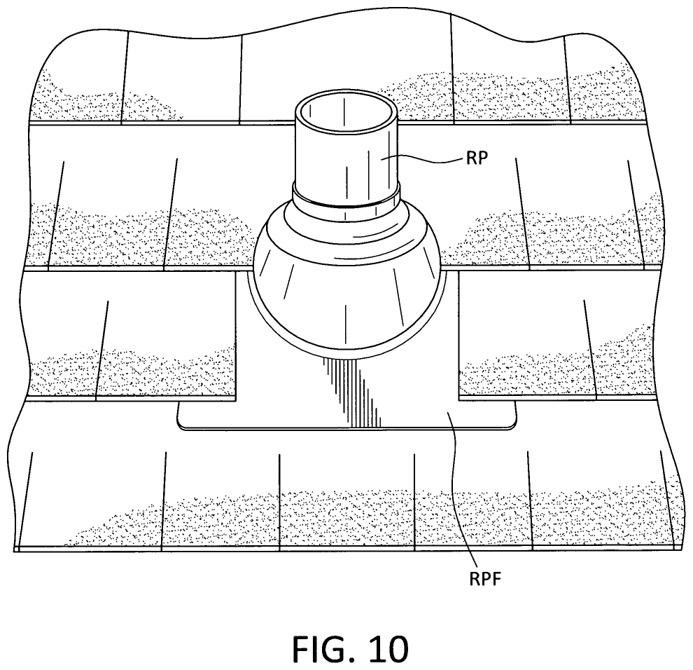

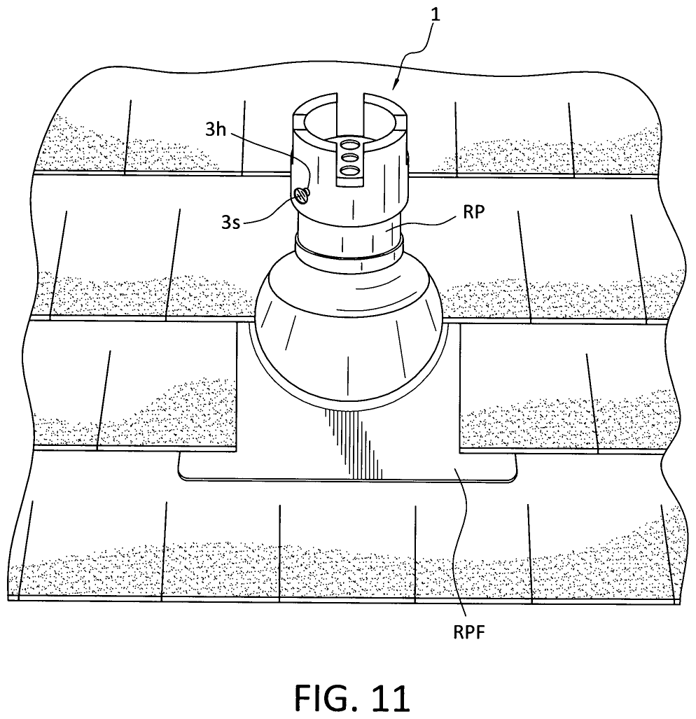

FIG. 9, as previously indicated, shows the resulting completed assembly of the components of the ornamental support member 1 with an eagle ornament EO supported thereon.

FIG. 10 shows a typical roof pipe flashing RPF with an exhaust roof pipe RP protruding therethrough which roof pipe flashing RFP is secured to the shingled roof of a house.

FIG. 11 shows the ornamental support member 1 slid over the cylindrical exhaust roof pipe RP and secured thereto by means of a threaded screw 3s which is screwed into a threaded hole 3h in the sidewall of the ornamental support member 1 and tightened making contact with the exhaust roof pipe RP.

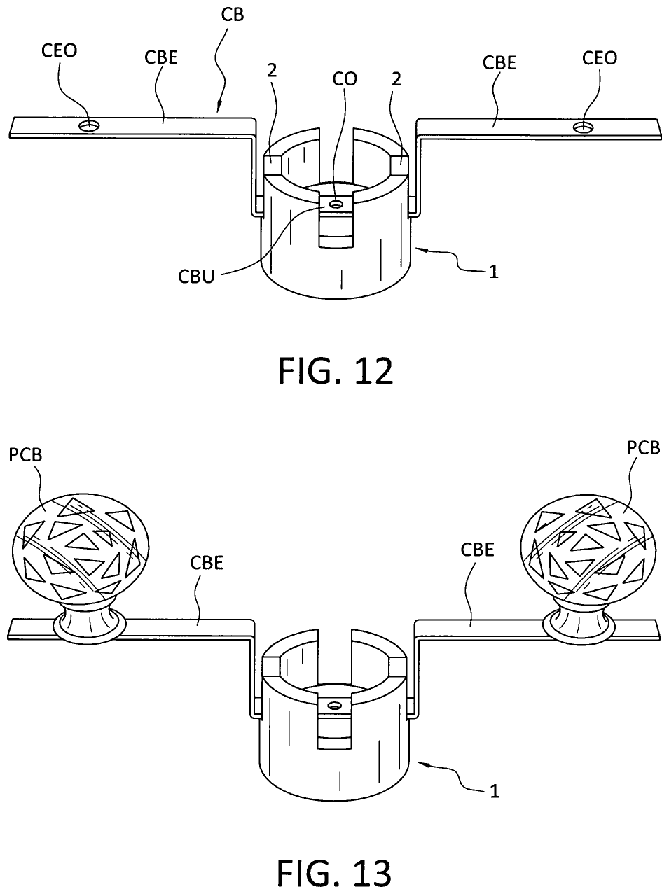

In FIG. 12 there is shown a modification of the ornamental support member 1 of this invention with a crossing bar CB positioned within a pair of opposite cut-outs 2, 2 in the ornamental support member 1. The crossing bar CB has a central U-shaped section CBU with an extension CBE from each side thereof. The bottom of the U-shaped section CBU has a length of approximately 4 and ½ inches with each upright leg of the U-shaped section having a length of approximately 2 and ½ inches. Each of the extensions CBE has a length of approximately 5 and ½ inches. The bottom of the U-shaped section CBU has a central opening CO of approximately ½ inch and each of the extensions CBE has a circular opening CEO of approximately ½ inch about 2 inches from its free end.

In FIG. 13, there is shown the modification in FIG. 12 of an ornamental support member 1 with a plastic crystal ball PCB supported from and near each end of the crossing bar extension CBE with a threaded bolt (not shown in FIG. 13) extending from the plastic crystal ball PCB through a circular extension opening CEO (not shown in FIG. 13). Each plastic crystal ball PCB is secured to a respective crossing bar extension CBE by means of a nut (not shown in FIG. 13).

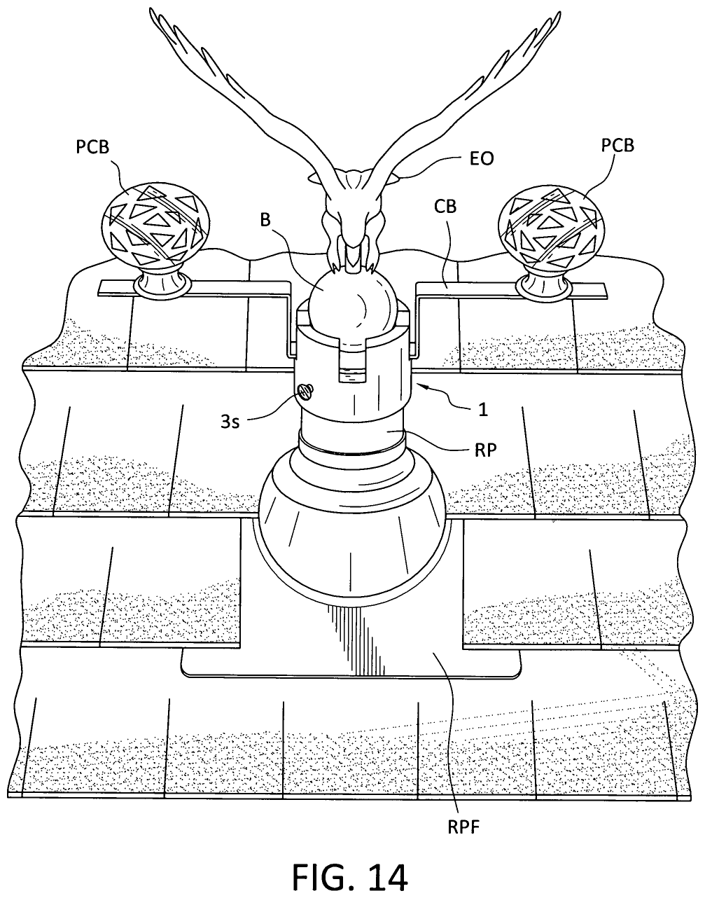

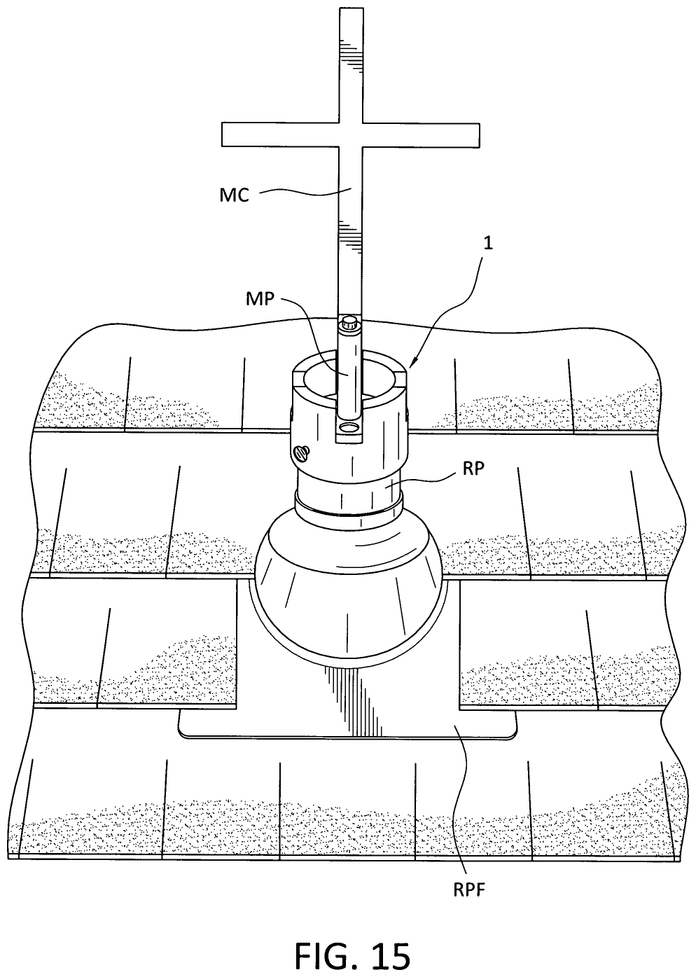

In FIG. 14 there is shown an embodiment utilizing the modification of the ornamental support member 1 shown in FIG. 13. In this embodiment an eagle ornament EO is supported from the ornamental support member 1 with a crossing bar CB inserted therein and a plastic crystal ball PCB attached to opposite ends of the crossbar CB. As would be understood by one having ordinary skill in the art ornaments other than plastic crystal balls may also be used in place thereof in this modified embodiment of the ornamental support member 1 of this invention. The ornamental support member 1, supporting the eagle ornament EO, is shown slid over the exhaust roof pipe RP surrounded by an exhaust roof pipe flashing RFP.

In another embodiment shown in FIG. 15 for the support of a decorative metal cross MC, there is a metallic pipe MP attached to the bottom end of the decorative metal cross MC which metallic pipe MP has a diameter larger than the diameter of the central opening in the metallic inner disc 4 (not identified in FIG. 15) for additional support of the metal cross MC on the ornamental support member 1. The usual elongated threaded bolt (not seen in FIG. 15) is attached to the metal cross MC and passes through the metallic pipe MP to the opposite side of the disc 4 and a threaded nut (TN not seen in FIG. 15) is screwed onto the threaded bolt (not seen in FIG. 15) up to the bottom side of the metal disc 4 and tightened to secure the decorative metal cross MC to the ornamental support member 1. Of course, one having ordinary skill in the art would readily realize that sturdy materials other than metal could also be used for the cross and pipe supporting the cross.

The second embodiment of this invention is an ornamental support member 1A which will now be described with respect to FIGS. 16-26. The ornamental support member 1A has an outer elongated truncated cone-shaped component 2a and an inner elongated cylindrically shaped component 3a integrally attached to an upper end 4a of the outer cylindrical component 2a. The outer elongated truncated cone-shaped component 2a has a threaded hole 2h approximately one inch down from the top end 4a thereof the purpose of which will be explained later herein. This ornamental support member 1A is designed to fit and slide over a two-inch roof pipe RP. The inner diameter at the upper end 4a of the outer elongated truncated cone-shaped component 2a is approximately ¼ inch larger than the outer diameter of the roof pipe RP in order that it can be easily slid over a present-day conventional roof pipe RP having a wall thickness of approximately 3/16 inch or an older type roof pipe RP having a wall thickness of approximately 4/16 inch. The upper end 4a of the ornamental support member 1A has a rim 5a of approximately ¼ inch. The outer diameter of the inner cylindrically shaped component 3a is approximately slightly less (e.g., 1-2 mm) than the inner diameter of the roof pipe RP such that the inner cylindrically shaped component 3a can be completely inserted into the bore of the roof pipe RP. The material of the ornamental support member 1A is made from ABS plastic, aluminum, steel or other well-known, sturdy and durable material. The spacing between the outer elongated truncated cone-shaped component 2a and the inner elongated cylindrically shaped component 3a is approximately the thickness of the two-inch cylindrical roof pipe RP, i. e., 3/16 inch. The central height of the outer elongated truncated cone-shaped component 2a is approximately 4 and ¾ inches but could vary somewhat as long as it sufficiently covers a substantial length of the roof pipe RP, e. g., 4-7 inches. The length of the inner cylindrically shaped component 3a is approximately 1 and ¾ inches but could vary between 1 and ½ inches to 5 inches provided that the length of the inner cylindrically shaped component 3a is generally shorter than the length of the outer truncated cone-shaped component 2a and that the elongated threaded bolt TB can be threaded by a threaded nut TN at its bottom end. The outer truncated cone-shaped component 2a has a threaded hole 6a in its side wall for the insertion of a set screw 2S in order to firmly secure the ornamental support member 1A onto the cylindrical roof pipe RP. The hole 6a is approximately 1 inch down from the upper end 4a of the outer truncated cone-shaped component 2a. The upper end 4a of the outer truncated cone-shaped component 2a is provided with a disc 7a having a diameter of approximately 2 and ¼ inches and the lower end 4b of the inner cylindrically shaped component 3a is provided with a disc 8a having a diameter of approximately 1 and ¾ inches. Each disc 7a and 8a has a center hole 9a of approximately 9/16 inches to accommodate a one-half inch threaded bolt TB therethrough the purpose of which will be explained later herein. Each of the discs 7a and 8a has several holes spaced around the center hole 9a to allow outside air to enter the roof pipe RP and undesirable gas to exit from the roof pipe RP into the atmosphere as is well understood by those skilled in the roofing art. The size and number of holes surrounding the center hole 9a in each disc 7a, 8a may vary; for this embodiment there are 8 holes each having a diameter of approximately 5/16 inch. Disc 7a can be permanently affixed to the upper end 4a of the outer truncated cone-shaped component 2a and disc 8a can be permanently affixed to the lower end 10a of the inner cylindrically shaped component 3a. All component parts of the ornamental support member 1A can be made by injection molding into a monolithic unit. In addition to the outer and inner components (2a, 3a) of the ornamental support member 1A, the ornamental support member 1A includes an elongated threaded bolt TB which is attached to a bottom end of the ornament itself and a pair of one-half inch internally threaded nuts TN. In effect, the ornamental support member 1A of this invention includes an elongated threaded bolt TB, an upper one-half inch threaded nut TN, outer and inner components (2a, 3a), upper and lower discs (7a, 8a), and a lower one-half inch threaded nut TN. Alternatively, the two discs 7a and 8a can be manually adjoined to the ornamental support member 1A during the physical attachment of a decorative ornament to the ornamental support member 1A which procedure will be explained later herein. In use, the inner cylindrically shaped component 3a of the ornamental support member 1A is inserted into the bore of the roof pipe RP such that the cylindrical wall of the roof pipe RP is firmly positioned between the inner cylindrically shaped component 3a and the outer truncated cone-shaped component 2a.

Although the dimensions given herein are designed for using the ornamental support member 1A with a two-inch roof pipe RP it can be appreciated that the dimensions for an ornamental support member 1A can be readily determined (by roofers skilled in the art) for other conventional roof pipes having diameters of 1.5 inches, 3.5 inches or 4.0 inches.

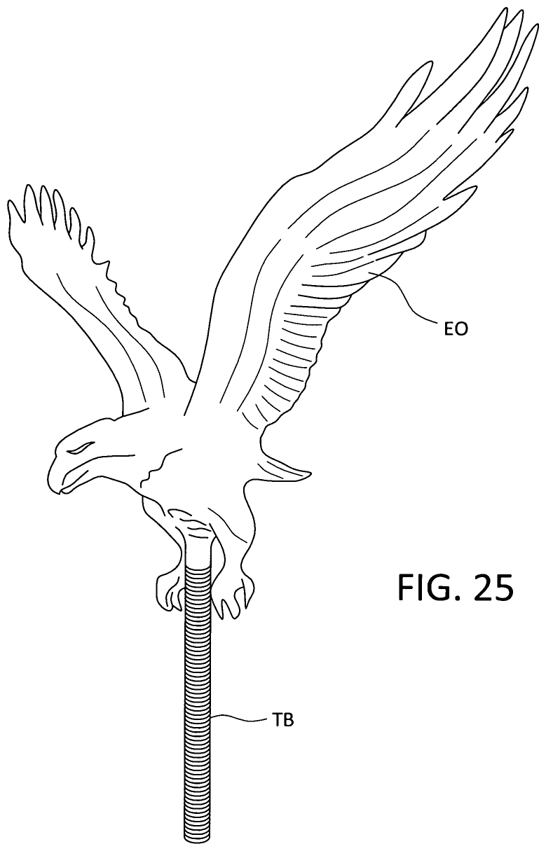

FIG. 25 is a separate view showing an elongated threaded bolt TB physically attached to the bottom end of the decorative ornament EO.

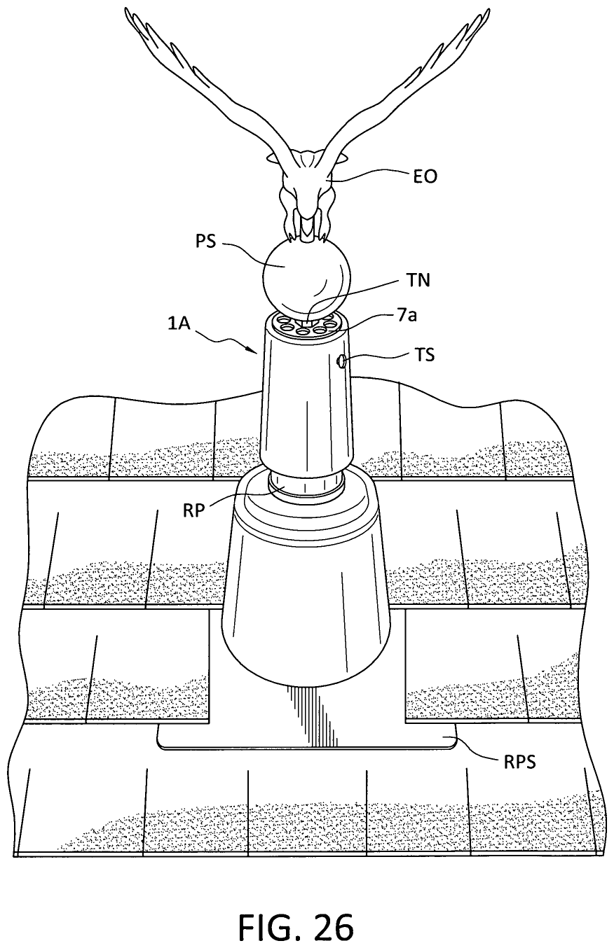

In particular, FIG. 26 shows the manual assembling of the separate parts of the ornamental support member 1A to an eagle ornament EO with an elongated threaded bolt TB (approximately 7 inches long) physically attached at the lower end of the eagle ornament EO. A physical sphere PS (approximately 3 inches in diameter and with aligned holes at opposite ends of the physical sphere PS) is manually slid up the free end of the elongated threaded bolt TB until it is stopped from progressing further by the claws of the eagle ornament EO. Then a threaded nut TN one half inch in inner diameter is screwed unto the threaded bolt TB until it presses against the lower end of the physical sphere PS and securely locks the physical sphere PS between it and the claws of the eagle ornament EO. The next step is to apply the components of the ornamental support member 1A unto the treaded bolt TB attached to the bottom end of the eagle ornament EO by sliding the larger diameter disc 7a of the ornamental support member 1A up the free end of the threaded bolt TB until it touches the threaded nut TN. Then, the ornamental support member 1A (comprising its outer truncated cone-shaped component 2a and its inner cylindrically shaped component 3a) is slid up the free end of the treaded bolt TB until it abuts the larger diameter disc 7a of the ornamental support member 1A. Subsequently, the smaller diameter disc 8a of the ornamental support member 1A is manually slid up the free end of the threaded bolt TB until it abuts the lower end of the inner cylindrically shaped component 3a. A lock nut LN is slipped onto the free end of the threaded bolt TB until it abuts the bottom side of the smaller diameter disc 8a. Finally, another threaded nut TN (similar to the previous threaded nut TN) is screwed unto the free end of the threaded bolt TB until it abuts the lock nut LN and is tightened enough to securely lock together the prior mentioned separate parts in an immovable manner such as shown in the completed assembly of FIG. 26.

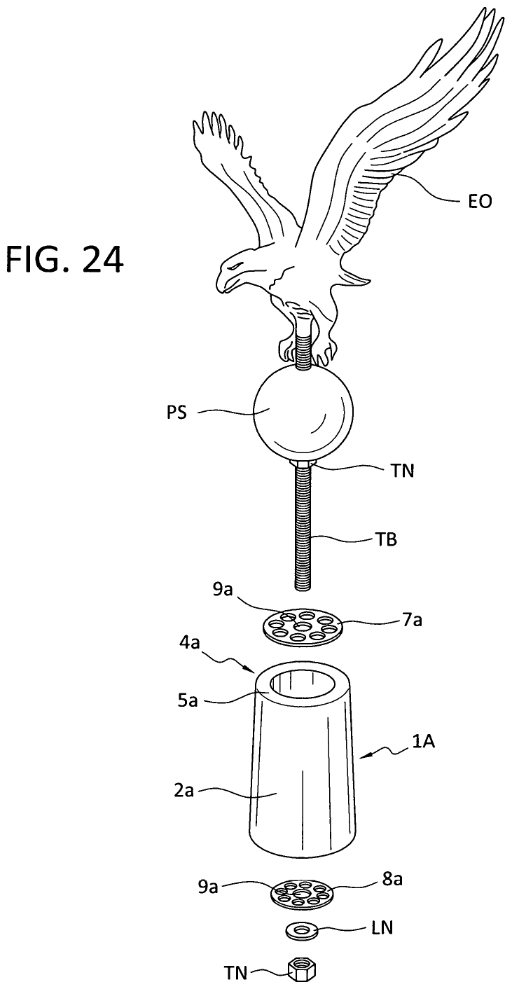

The completed assembly of the eagle ornament EO and the ornamental support member 1A shown in FIG. 24 is then slid over a two-inch roof pipe RP of a shingled roof as shown in FIG. 26. In order to secure the completed assembly to the roof pipe RP a tension screw TS is screwed into the threaded hole 2h until it makes contact with the roof pipe RP and tightened to firmly secure the completed assembly to the roof pipe RP. As shown in FIG. 24, the two-inch roof pipe RP extends through a roof pipe shielding RPS. Alternatively, instead of the manual assembly of the separate components of the ornamental support member 1A, the separate parts, i. e., the outer and inner components 2a and 3a, the upper larger diameter disc 7a and the lower smaller diameter disc 8a can all be made by an injection molding process such that they form a monolithic structure thus avoiding several of the steps in the manual assembly of some of the separate parts explained in the previous paragraph. One having ordinary skill in the roofing art would know how to assemble the completed assembly shown in FIG. 26 with the discs 7a and 8a pre-attached to the ornamental supported member 1A by an injection molding process well known in the art.

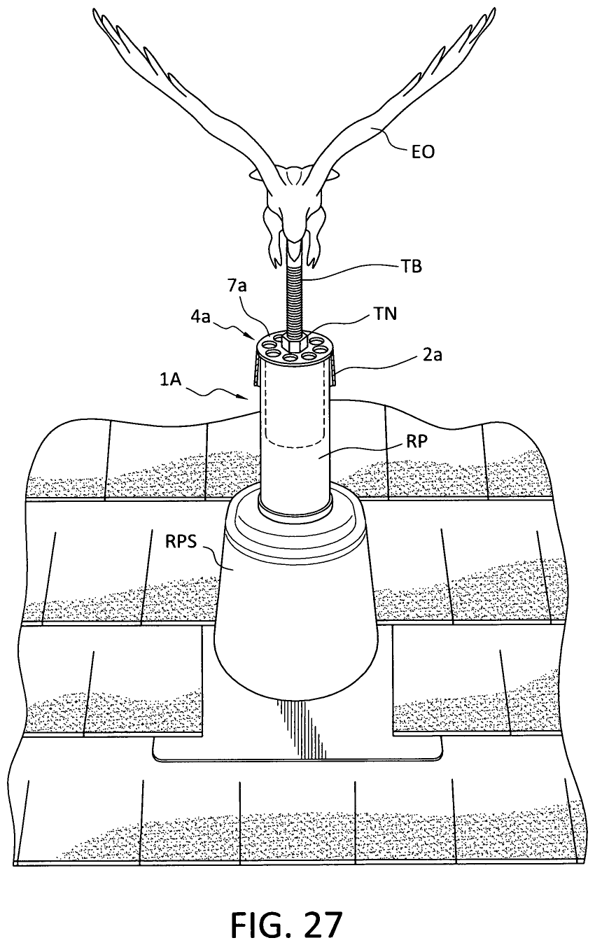

As shown in FIG. 27, the combination of the decorative ornament EO and the ornamental support member 1A is similar to the combination shown in FIG. 26 but with the physical sphere PS removed if the physical sphere is not desired. If desired, another decorative ornament, such as a religious cross or other symbolic ornament may be used in place of the eagle ornament EO.

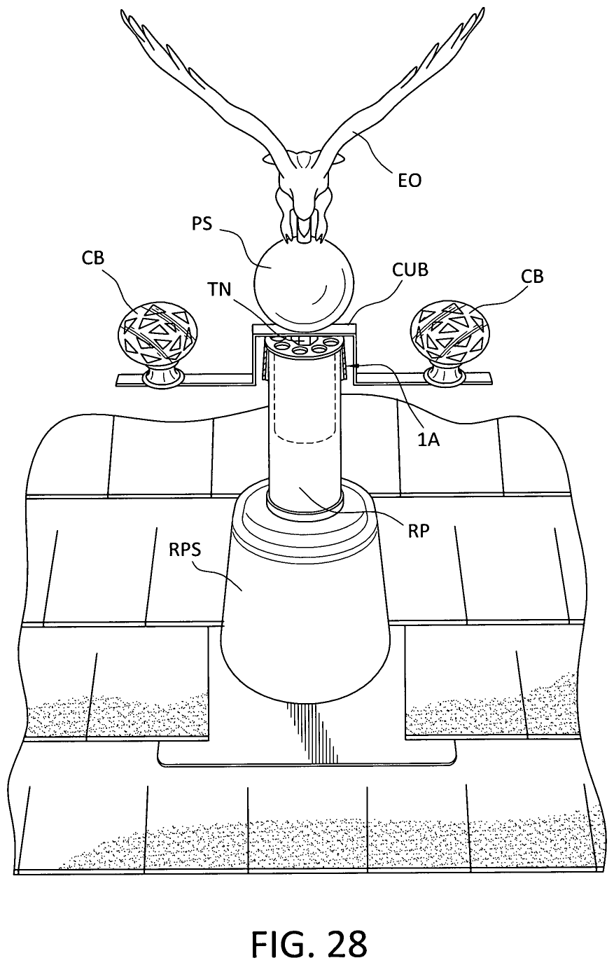

As shown in FIG. 28 an additional decoration may be attached to the combination shown in FIG. 26 such as a crossing U bar CUB, as shown In FIG. 12, with a pair of crystal balls CB attached at opposite ends of the crossing bar CB.

An alternative shape for the elongated outer component 2a is to make it cylindrically shaped instead of a truncated cone-shape in which case the elongated length of the outer component 2a is approximately 4 and ¾ inches. The spacing between the outer elongated truncated cone-shaped component 2a and the elongated cylindrically shaped component 3a is approximately the same as it is at the top end 4a of the ornamental support member 1A. The other components of the ornamental support member 1A remain the same as well as its structural assembly as explained hereinbefore.

Modifications of this invention will be readily apparent to those skilled in the art and it is intended that the invention be not limited by the embodiments disclosed herein but that the scope of the invention be defined by the appended claims.

What is claimed is:

1. An ornamental support member for supporting a decorative ornament from an exhaust roof pipe of a building comprising an outer elongated truncated cone-shaped component having a predetermined length and an inner elongated cylindrically shaped component having a predetermined length shorter than said predetermined length of said outer truncated cone-shaped component and spaced from said outer truncated cone-shaped component, said outer truncated cone-shaped component having an upper end and a lower end, said inner elongated cylindrically shaped component having an upper end and a lower end, said upper end of said outer elongated truncated cone-shaped component being attached to said upper end of said inner elongated cylindrically shaped component by a cylindrical rim having an upper surface, a first disc being in abutment with an upper side of said cylindrical rim, said first disc having a central hole and a plurality of holes spaced around said central hole to provide for exhaust air to exit from said roof pipe into the atmosphere, a second disc being in abutment with said lower end of said inner elongated cylindrically shaped component, said second disc having a central hole and a plurality of holes spaced around said central hole to provide for the passage of exhaust air from said roof pipe through said inner elongated cylindrically shaped component and said first disc and said second disc having a diameter less than the diameter of said first disc.

2. The ornamental support member of claim 1 wherein said first disc is permanently attached to said upper surface of said cylindrical rim and said second disc is permanently attached to said bottom end of said inner elongated cylindrically shaped component.

3. The ornamental support member of claim 2 wherein said outer elongated truncated cone-shaped component, said inner elongated cylindrically shaped component, said cylindrical rim and said first and second discs are formed by injection molding.

4. The ornamental support member of claim 3 wherein said ornamental support member is a monolithic structure.

5. The ornamental support member of claim 2 wherein a first threaded nut abuts an upper surface of said first disc and is aligned with said central hole in said first disc and wherein a second threaded nut abuts a bottom surface of said second disc and is aligned with said central hole in said second disc and wherein said central hole in said first disc and said central hole in said second disc are in longitudinal alignment with each other.

6. The ornamental support member of claim 5 wherein a lock nut is sandwiched between said bottom surface of said second disc and said second threaded nut.

7. The ornamental support member of claim 1 wherein said ornamental support member is slid over said exhaust roof pipe of a building such that said cylindrically shaped component is completely inserted into the bore of said roof pipe.

8. The combination of an ornamental support member of claim 7 and a decorative ornament, wherein said decorative ornament has an upper end and a lower end, an elongated threaded bolt being attached to said bottom end of said decorative ornament whereby said threaded bolt is threaded through a first threaded nut, passed through said ornamental support member, and threaded through a second threaded nut, all secured together in a tightened manner.

9. The combination of claim 8 wherein said ornamental support member with said decorative ornament attached thereto is slid over said exhaust roof pipe of a building such that an upper portion of said exhaust roof pipe is sandwiched between said outer elongated truncated cone-shaped component and said inner elongated cylindrically shaped component.

10. The combination of claim 9 wherein said outer elongated truncated cone-shaped component has a threaded hole therein for the insertion of a set screw which contacts said exhaust roof pipe in a tightened manner in order to secure said combination to said exhaust roof pipe.

11. A combination of an ornamental support member for an exhaust roof pipe of a building and a decorative ornament attached to said ornamental support member, said ornamental support member comprising an outer elongated truncated cone-shaped component and an inner elongated cylindrically shaped component, said inner elongated cylindrically shaped component being shorter lengthwise than said outer elongated truncated cone-shaped component, said inner elongated cylindrically shaped component being spaced from said outer elongated truncated cone-shaped component, said outer elongated truncated cone-shaped component having an upper end and a lower end, said inner elongated cylindrically shaped component having an upper end and a lower end, said upper end of said elongated truncated cone-shaped component being attached to said upper end of said inner elongated cylindrically shaped component by a cylindrical rim, a first disc being in abutment with an upper surface of said cylindrical rim, said first disc having a central hole and a plurality of holes spaced around said central hole, a second disc being in abutment with said lower end of said inner elongated cylindrically shaped component, said second disc having a central hole and a plurality of holes spaced around said central hole, said second disc having a diameter less than the diameter of said first disc, said decorative ornament having an upper end and a lower end with an elongated threaded bolt attached to said bottom end of said decorative ornament, said elongated threaded bolt being threaded through an upper threaded nut in abutment with an upper surface of said second disc, passing through said ornamental support member, and threaded through a lower threaded nut in abutment with a lower surface of said second disc.

12. The combination of claim 11 wherein there is a threaded hole in the upper end of said outer elongated truncated cone-shaped component and a set screw threaded through said threaded hole whereby said set screw makes contact with said exhaust roof pipe in order to secure said combination to said exhaust roof pipe of said building.

13. The combination of claim 12 wherein there is a lug nut between said second disc and said second threaded nut.

14. The combination of claim 13 wherein said decorative ornament is an eagle.

15. The combination of claim 14 wherein said building is a residential house.

16. The combination of claim 11 wherein there is a spherical ball positioned between said lower end of said decorative ornament and said upper threaded nut, said spherical ball having opposing holes therein for the passage of said threaded bolt therethrough.

17. The combination of claim 12 wherein there is a threaded hole in the upper end of said outer truncated cone-shaped component and a set screw threaded through said threaded hole whereby said set screw makes contact with said exhaust roof pipe in order to secure said combination to said exhaust roof pipe of said building.

18. The combination of claim 17 wherein there is a lug nut between said second disc and said second threaded nut.

19. The combination of claim 18 wherein said decorative ornament is a religious cross supported by said ornamental support member, said religious cross having an elongated threaded bolt fixedly attached to a bottom end of said religious cross and wherein there is a threaded nut screwed onto said elongated threaded bolt adjacent said first disc at said top end of said ornamental support member and a threaded nut screwed onto said elongated threaded bolt at said bottom end of said inner cylindrically shaped component adjacent said second disc such that said decorative ornament is secured to said ornamental support member.

20. The combination of claim 19 wherein said building is a residential house.
